(19) United States
(12) Patent Application Publication
(10) Pub. No.: US 2004/0073640 A1
(43) Pub. Date: Apr. 15, 2004

(54) Network load management apparatus, system, method, and electronically stored computer product

(75) Inventors: John Martin, Great Falls, VA (US); Robert Gibson, McLean, VA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: CRICKET TECHNOLOGIES LLC, Reston, VA

(21) Appl. No.: 10/252,049

(22) Filed: Sep. 23, 2002

(51) Int. Cl. G06F 15/173; H04L 12/28

(52) U.S. Cl. 709/223; 370/351

(57) ABSTRACT

An apparatus, system, method, and computer program product configured to dynamically balance traffic loads between an originating device and a global network so as to maintain efficient communications across the global network between the originating device and remote device. Data packets are transmitted over multiple network connections, where the performance characteristics of each network connection is monitored in advance so as to assist in determining which network connection is to be assigned to any given data packet.

### BACKGROUND OF THE INVENTION

1. Field of the Invention

The present invention relates to systems, apparatuses, methods, and computer program products that perform dynamic and transparent load balancing between inbound and outbound electronic message traffic.

2. Discussion of the Background

Interdomain routing was developed in the 1980's as a way of homogenously connecting multiple routing domains. A common protocol for interdomain routing is the border gateway protocol (BGP). BGP is used extensively in the Internet and in Intranet applications. An overview of BGP is found in Juniper Networks Routers, the Complete Reference, edited by Jeff Doyle and Matt Kolon, Osborne McGraw-Hill; ISBN: 0072194812; (Feb. 12, 2002), the entire contents of which is hereby incorporated by reference.

BGP Version 4 is the current exterior routing protocol used to “glue” the Internet together. Each Internet service provider uses BGP to logically connect to other ISPs. Some enterprises, particularly the larger ones, use BGP to connect to one or more ISPs for access to and from the Internet. In addition, these large enterprises often use BGP as the protocol of choice to interconnect their internal corporate domains. BGP passes required routing information between routing domains, and this routing information is what routers use to determine where to send fP datagrams.

BGP does not provide packet diversification since the BGP protocol requires that an entire file be transmitted over a single port instead of being transmitted packet-by-packet over a variety of ports. The Internet Engineering Task Force (IETF) Request for Comment (RFC) entitled “A Border Gateway Protocol 3”, RFC 1267, dated October 1991, the entire contents being hereby incorporated by reference, provides a summary of BGP operations, an excerpt of which follows:

[T]wo systems form a transport protocol connection between one another.

They exchange messages to open and confirm the connection parameters. The initial data flow is the entire BGP routing table. Incremental updates are sent as the routing tables change. BGP does not require periodic refresh of the entire BGP routing table. Therefore, a BGP speaker must retain the current version of the entire BGP routing tables of all of its peers for the duration of the connection. ‘Keep alive’ messages are sent periodically to ensure the aliveness of the connection. Notification messages are sent in response to errors or special conditions. If a condition encounters an error condition, a notification message is sent and the connection is closed.

FIG. 1 is a simplified view of the background art in which a site 101 hosts numerous devices on a LAN 105 which communicate with devices outside the site via a BGP router 103. This BGP router 103 may be connected to a first ISP 107 and/or to a second ISP 109. Load balancing of service between the first ISP 107 and second ISP 109 is performed by the BGP router 103. Numerous commercial devices exist to balance network loading amongst various connections. One example is the CISCO 7000 family series of multi-protocol routers. Within these routers, network interfaces reside on modular interface processors, which provide a direct connection between high speed buses and external networks. Distributive processing is accomplished by a route processor, switch processor, and silicon switch processor. Using only an existing commercial router and its proprietary software to balance network is expensive to setup and to maintain. These devices perform a version of dynamic BGP by addressing line availability and routing. However, as recognized by the present inventors, these devices alone do not perform detailed performance-based or cost-based load balancing.

As recognized by the present inventors, a superior network load device would be capable of performing cost-based balancing by comparing state status and quality of service requirements without requiring the cost and complexity of BGP. Furthermore, the present inventors recognize the desirability of having a transparent and automatic load balancing device that allows assets on an Intranet to interface with the Internet without requiring local protocols and that has no impact upon throughput of networks. Ideally, such as device would add security to virtual private networks through packet transmission diversification. Randomization across mobile ports would allow for greater security in virtual private networks. BGP is based upon local line checking, and thus is not capable of random cross line pinging. Thus, currently, there is a need for an effective way to load balance and fast recover from line or ISP outages.

### SUMMARY OF THE INVENTION

The present invention addresses and resolves the above-identified as well as other limitations with conventional network load balancing devices and methods. The present invention provides a low-cost, easy to implement and easy to maintain infrastructure and technology for network load balancing. The present invention includes a network load management apparatus that enables cost-effective and secure internetwork and interdomain information exchange.

In the present invention, the network load management apparatus provides:

Automatic reallocation of bandwidth;

Packet randomization;

Dynamic domain name server identification;

Channel bonding;

Transparent network management; and

Dynamic packet level encryption

The present invention is configured to dynamically balance traffic loads between an originating device and a global network so as to maintain efficient communications across the global network between the originating device and remote device.

### BRIEF DESCRIPTION OF THE DRAWINGS

A more complete appreciation of the present invention and many of the attendant advantages thereof will be readily obtained as the same becomes better understood by reference to the following detailed descriptions and accompanying drawings:

FIG. 1 is a block diagram that illustrates a conventional method for network load balancing;

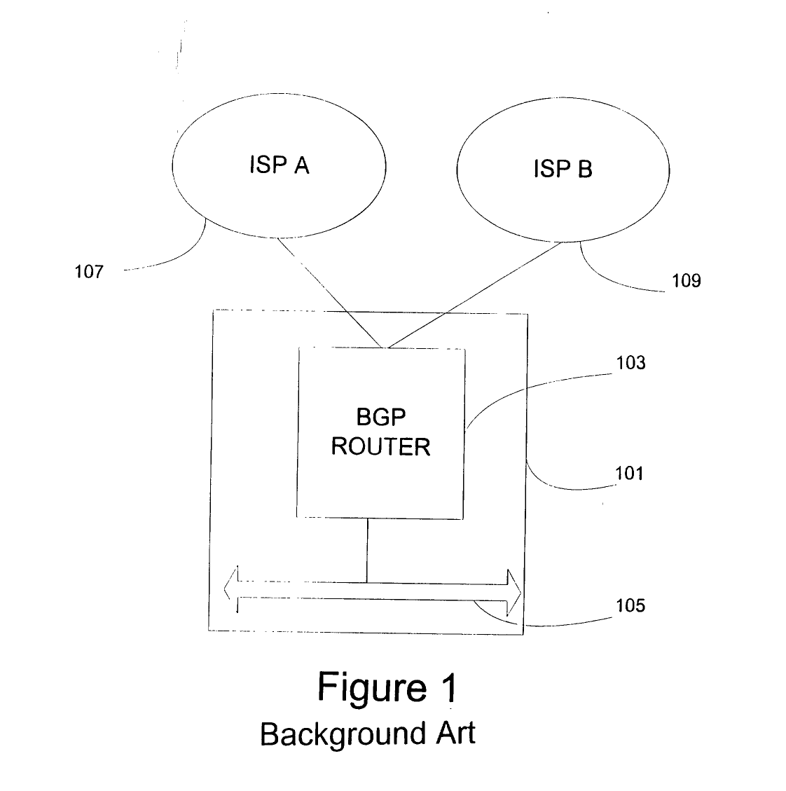

FIG. 2 is a block diagram of one embodiment of the present invention;

FIG. 3 is a block diagram of a second embodiment of the present invention;

FIG. 4 is a block diagram of a third embodiment of the present invention;

FIG. 5 is a block diagram of a fourth embodiment of the present invention;

FIG. 6 is a high level of the software suite associated with the present invention;

FIG. 7 is a detailed block diagram of one module of the software suite associated with the present invention;

FIG. 8 is a flow diagram for the fail/safe guardian operation of the present invention;

FIG. 9 is a flow diagram for the real-time executive operation of the present invention;

FIG. 10 is a block diagram showing how one network load management apparatus may back-up another remote network load management apparatus;

FIG. 11 is a block diagram showing how multiple network load management apparatuses may be managed from a central location; and

FIG. 12 is a block diagram of a computer system upon which an embodiment of the present invention may be implemented.

### DETAILED DESCRIPTION OF THE PREFERRED EMBODIMENTS

The network load management apparatus of the present invention provides a unique, affordable, easy-to-use, and dynamic alternative/addition to BGP-based and other known routing paradigms in that it is capable of balancing loads between multiple devices and multiple links via set of robust and sophisticated functional processes each predicated on a wide array of line characteristics and network management objectives. Each of the functional processes of the network load management apparatus are performed by one or more modules or software, firmware, hardware, or combinations thereof.

The network load management apparatus of the current invention provides an efficient and inexpensive way for business entities to have fault tolerant and redundant Internet access. The network load management apparatus provides high availability and redundant connections to the Internet, or other outbound networks, via multiple Internet service providers (ISPs). The network load management apparatus can be installed at multiple locations to provide end-to-end network load management functions for distributed enterprises. The network load management apparatus provides automatic recovery from failed connections of multi-homed web servers and permits balancing of Internet and Internet-like traffic between multiple Internet service providers (ISPs).

The network load management apparatus of the present invention is configured to persistently monitor and detect quality and state of service for each line connecting a home operation to an ISP. Exemplary lines include DSL, cable, T-1, and T-3, and more generically applies to communication links in general, and thus cover dial-up connections (e.g., via PSTN) as well as wireless links (such as over cellular networks) The network load management apparatus monitors connected lines for capacity utilization and quality of service. The network load management apparatus then balances these monitored parameters against a set of local configuration parameters/predetermined levels of performance such as predetermined output rate, predetermined output quality, cost of service, packet priority, security, predetermined queue size, as well as other common management profile parameters. The network load management apparatus processes these monitored and local parameters as it routes packets on a second-by-second basis (although other sub-second time intervals may be used such as at 10 ms, or 100 ms, as well as time intervals above one second, such as 10 second intervals) to its multiple output ports so as to optimize traffic routing and management. On a receiving end, the network load management apparatus receives and reconstructs packets before routing them to destination devices. The network load management apparatus uses an embedded routing decision algorithm to perform “load balancing” via link aggregation. The network load management apparatus detects failures by monitoring a variety of conditions (such as dropped packet rate, Bit error rate, signal-to-noise ratio, etc.) on both the communications line health and the TCP/EP “failure-to-respond-indicators”. The apparatus employs an active executive program that persistently monitors each outgoing network connection and makes corrective changes to load supplied to these outgoing network connections in response to observed link parameters and predetermined configuration parameters.

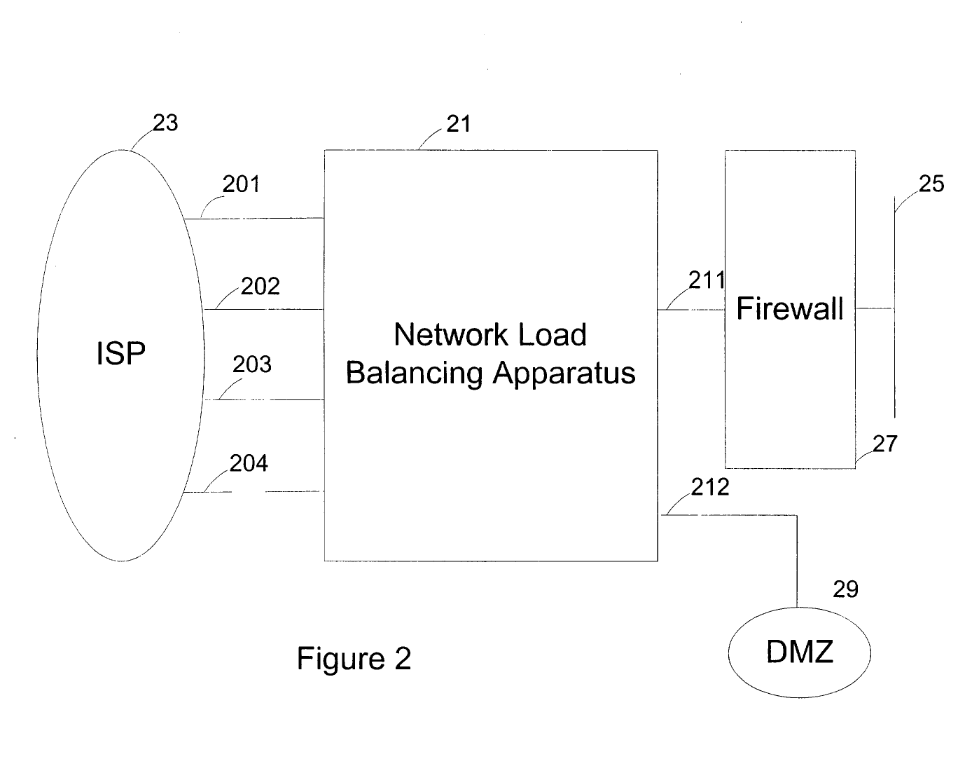

FIG. 2 is a block diagram of one embodiment of the network load management apparatus of the present invention. The network load management apparatus 21 is located between an Internet service provider (ISP) 23 and an Intranet 25. While only one ISP 23 is shown in FIG. 2, each of the output ports (shown to be 4, but more generally can be N) can be connected to multiple ISPs. The connection 211 to the Internet may be through a firewall 27, such that the clients computer resources connected on Intranet 25 are located behind the firewall. The network load management apparatus 21 may also connect to a non-firewall-protected “demilitarized zone” (DMZ). The network load management apparatus 21 may be connected to the ISP 23 by up to four lines 201, 202, 203, and 204.

Information originating from the Intranet 25 and/or the DMZ 29 is routed with a TCP/IP label to the network load management apparatus 21. Alternatively, the network load management apparatus of the present invention operates similarly with other networking protocols such as MPLS (multi-protocol label switching). The network load management apparatus 21 monitors the ISP 23 at regular intervals (such as second-by-second) via the output ports 201, 202, 203, and 204. The network load management apparatus 21 measures the line conditions in detail. BGP only knows a good or not good condition and does not evaluate how good a connection is, etc. (In BGP, condition is either UP or DOWN.) Packets arriving from the Intranet 25 and/or DMZ 29 are routed across the four or more ISP connections 201, 202, 203, and 204 in accordance with pre-assigned variables. Examples of pre-assigned variables include cyclic redundancy check (CRC), frame errors, carrier transitions, data carrier detect (DCD), loopback state, and input errors. The variables are assigned by a systems administrator when the network load management apparatus is installed or changed. By providing a diversity of output ports for individual packets, security may be increased for a virtual private network (VPN) as packets are distributed across multiple routes and are thus more difficult to be intercepted and are less vulnerable to noise or other performance degradations.

One aspect of the network load balancing apparatus 21 is that it provides a “smart” cross-bar switch function between the Intranet 25 and multiple lines to the ISP 23. From a computer on the Intranet 25, the network load balancing apparatus 21 performs a transparent function. Moreover, the network load balancing apparatus 21 receives the packet stream from the Intranet 25 and divides the packet stream into different substreams, according to the available capacity (or service level) of the lines 201-204, or different ISPs connected to lines 201-204. This division process is done as a function of the network load balancing apparatus' assessment of how easily the packets can be sent over the different lines 201-204 via the ISP 23 (or multiple ISPs). Thus, the division of packet flow and assignment of packets to specific lines 201-204 is performed dynamically so as to efficiently and speedily route the packets over the Internet.

As an alternative to assigning packets according to a dynamic assessment of the throughput capacity of the lines 201-204, the network load balancing apparatus 21 may configured to apply a weighting metric to the different lines 201-204 according to a user-settable criteria, such as cost. As an example, suppose lines 201-204 are each connected to different ISPs and the different ISPs offer different pricing policies based on the amount of traffic handled by them. In this case, the network load balancing apparatus 21 may apply a higher weighting factor to the line that connects to the less-expensive ISP so that more traffic is sent via the least costly ISP. On the other hand, if time of deliver is of paramount concern, the network load balancing apparatus 21 may direct the packets to travel over the line that will have the lowest latency. The network load balancing apparatus 21 may dynamically switch between weighting schemes. In one example, the network load balancing apparatus 21 may use the weighting scheme that uses the least costly route for traffic that occurs outside of peak business hours, and uses the other set of weights to minimize latency during peak business hours.

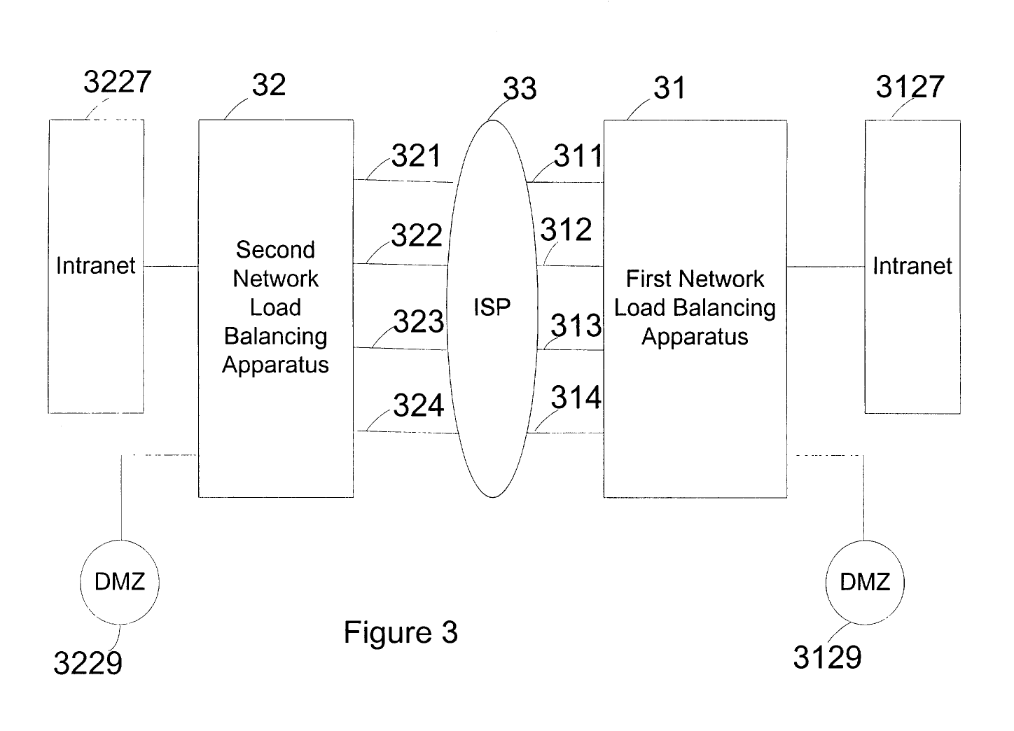

FIG. 3 is a block diagram showing one embodiment of an end-to-end connection between a first network load management apparatus 31 and a second network load management apparatus 32 via an Internet service provider (ISP) 33. By having an end-to end network load balancing infrastructure, applications on one Intranet 3127 may interact with applications on a second Intranet 3227 via a distributed and cost-effective connection paradigm. In this embodiment, packets are routed from the first network load management apparatus 31 across multiple output ports 311, 312, 313, and 314. These unique output ports correspond to unique domain names server (DNS) addresses. These packets are routed through one or more ISPs 33 and then received at the remote network load management apparatus 32 on corresponding connections 321, 322, 323, and 324, which also correspond to unique DNS addresses. These packets are reassembled in the receiving network load management apparatus 32 and forwarded to the receiving Intranet 3227. Similarly, interactions between and amongst remote and local Extranets and DMZs are possible. The configuration shown in FIG. 3, with two cooperating network load balancing apparatuses, offers greater security than a traditional VPN because the packets are protected not only by encryption, but also by “channel diversity.” In order to compromise the full content of the traffic between the Intranets 3227 and 3127 (or DMZs 3129 and 3229), all of the links 311-314 and 321-324 would have to be compromised.

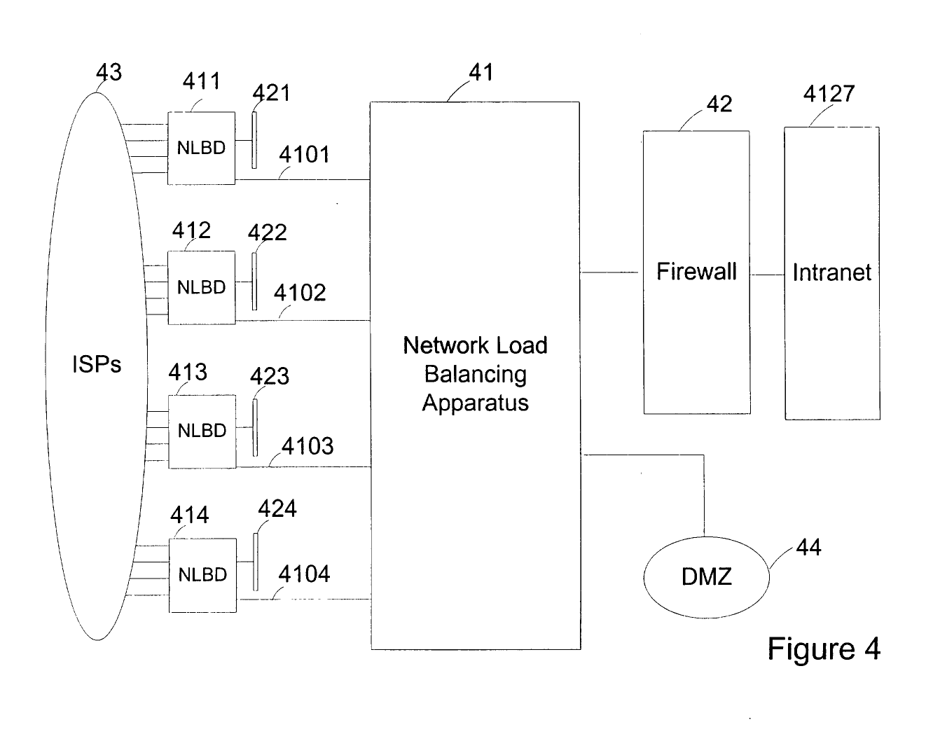

FIG. 4 is a block diagram illustrating how multiple network load balancing devices may be cascaded to provide greater route diversity and security. Moreover, the use of a cascaded set of network load balancing devices illustrates the scalability of such devices for making larger systems. Resources on an Intranet 4127 connect to a principle network load balancing device 41 by way of a firewall 42. In turn, the principle network load balancing device 41 divides the traffic flow into four candidate paths (more generally, N paths) that are connected to four additional network load balancing devices 411, 412, 413, and 414 via specific connections 4101, 4102, 4103, and 4104. Each network load management apparatus 411, 412, 413, and 414 may be connected (not shown) to the ISPs via the common firewall 42, or alternatively, each network load management apparatus may be connected via dedicated firewalls (e.g., 421, 422, 423, and 424). While one example is shown in FIG. 4, it should be clear that combinations and permeations of network load management apparatuses, firewalls, Internets, and DMZs, are possible through cascading of one or more network load balancing devices of the present invention.

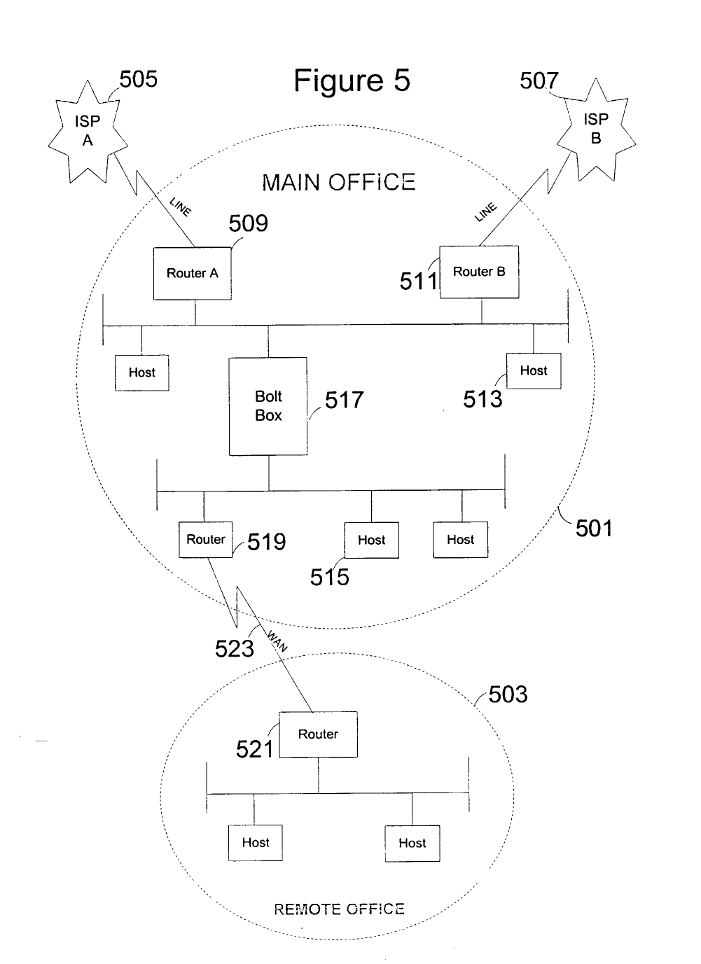

FIG. 5 is a block diagram of another embodiment of the present invention. In this embodiment, a corporation's main office 501 is provided Internet access via at least two ISPs 505 and 507 via external routers 509 and 511, respectively. A direct connection host 513 may route traffic to the Internet via either router. Alternatively, an indirect host 515 may route traffic to the Internet ISPs via the network load management apparatus 517. Traffic routed through the network load management apparatus 517 may be randomized or otherwise affected as previously described. In addition, a remote office 503 may be connected to the main office 501 via a pair of routers 521 and 519, and a wide area network 523. In this case, a remote office host 525 may have its traffic routed to the network load management apparatus 517 via the remote office router 521, a wide area network 523, and a main office background router 519. In this way, some traffic in the main office 501 and/or remote office 503 may be randomized or otherwise affected by the network load management apparatus 517, while other hosts' data is directly presented to the Internet. The main office non-randomized host 513 has its traffic routed to a single router, either router A 509 or router B 511. However, a host whose traffic is routed through the network load management apparatus 517 may have its traffic distributed between router A 509 and router B 511. Advantages of this capability include ease of set up, ease of operation, and robust performance.

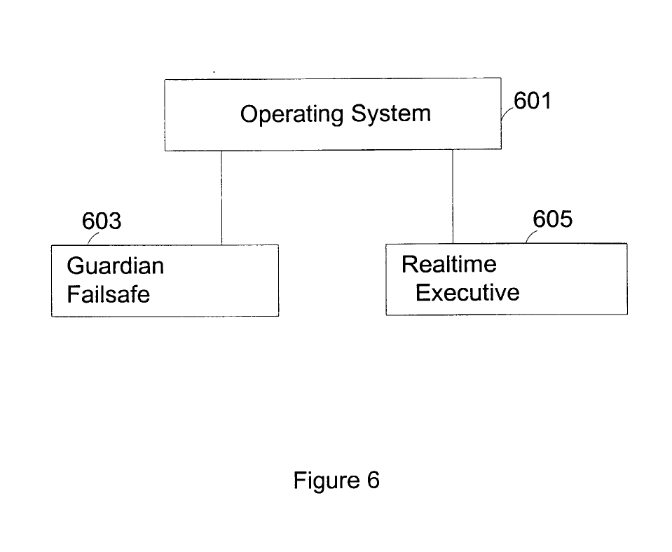

FIG. 6 is a block diagram of the software suite associated with the present invention. The software suite of the network load management apparatus includes an operating system 601 whose main components include a guardian fail/safe module 603 and a real-time executive 701. The guardian fail/safe module 603 is configured to ensure the real-time executive and other services are working properly. The real-time executive module 701 is configured to perform most of the monitoring functions of the network load management apparatus. All components of the software suite are executed in processor 1303 (FIG. 13) in combination with memories 1304, 1305 (FIG. 13).

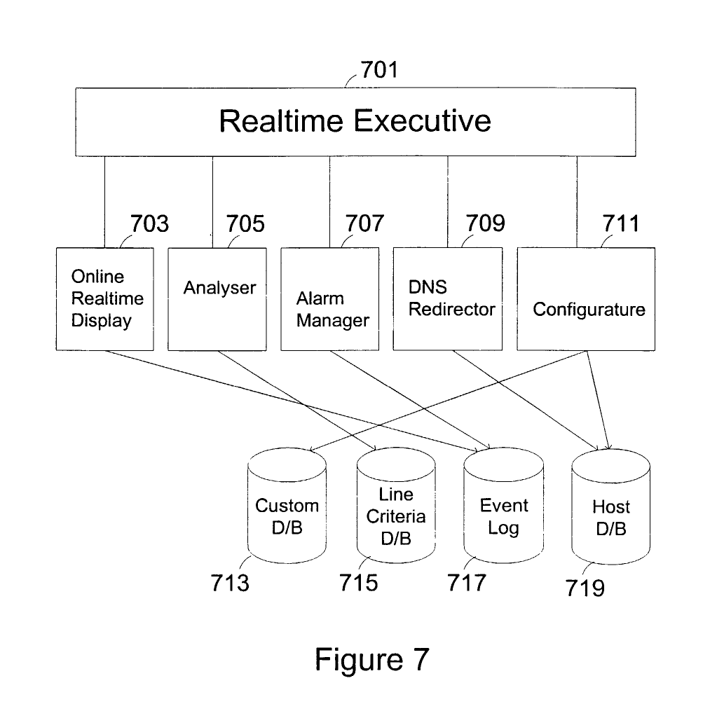

FIG. 7 is a block diagram of the major components of the network load management apparatus real-time executive 701. The real-time executive 701 includes an online real-time display 703 and analyzer 705 and alarm manager 707 and a domain name server (DNS) redirector 709, and a configurer module 711. The online real-time display 703 exchanges information with an event log 717. The analyzer module 705 exchanges information with a line criteria database 715. The alarm manager module 707 also exchanges information with the event log 717. The domain name server redirector exchanges information with the host database. The configuration module exchanges information both with the custom database 713 and the host database 719. The network load management apparatus also includes an alarm manager module which operates as follows: When the network load management apparatus real-time executive is notified by the analyzer module that a predetermined event-of-interest has occurred, the alarm manager logs associated event information, status and time information in an event log. The alarm manager can also cause the network load management apparatus to perform one or more of the following actions:

Send a notification e-mail to one or more interested parties;

Fax a notification report to one or more interested parties;

Page one or more interested parties;

Turn on one or more AC or DC backup power devices;

Execute a remote configuration change operation in one or many routers; and

Execute a remote configuration change operation on a host whose communications may be affected by the event causing the alarm.

The network load management apparatus is also capable of packet randomization. Packet randomization occurs when packets associated with a single message are routed over multiple ports of the present invention thereby providing a diversity of paths between the originating location and the receiving location. Packet randomization improves security by reducing the chance of interception by having packets routed across multiple connections. Packet randomization also improves performance against noise and other degradations as there is no single path of failure for an entire amount of traffic.

Packet randomization includes the addition of identifiers to each data packet so that each data packet may be dynamically encrypted. In addition, packets may be dynamically increased in size by a predetermined amount. This dynamic increase in size of a packet may be specific to a particular destination and/or source of information.

The network load management apparatus is also capable of dynamic domain name server allocation and reallocation. Each port is capable of being assigned to a specific domain name server address. If traffic is sent to a location that is also equipped with a network load balancing device of the present invention, a variety of domain name server addresses may be applied to the traffic thus providing a diversity of paths between the originating location and the receiving location.

The network load management apparatus also contains a configuration utility which enables an operator to set up and manage the network load management apparatus. Optionally, the network load management apparatus can be configured remotely if required. The device is pre-configured (out of the box) to respond on port 80 on 10.1.1. After initial setup with a correct IP address, the device is ready to be plugged into the desired LAN.

Using the configuration utility, an operator of the network load management apparatus can also perform local and remote host database management operations as follows: From the setup screen, a user enters all host-related information and DNS that will be managed with a corresponding and valid IP address that has been assigned and delegated from each ISP. Then, the runtime executive will update any changes in real-time to this data.

The network load management apparatus also contains a domain name server redirector which manages host IP addresses so as to prioritize address management information locally and/or remotely to establish a custom configuration. Optional custom configurations that can established include

a mode balance configuration whereby the network load management apparatus distributes predetermined records across all healthy ISP connections;

a mode prioritize configuration whereby the network load management apparatus distributes predetermined records to lowest cost or highest speed healthy connections; and

a mode random configuration whereby the network load management apparatus distributes predetermined records to all healthy ISP paths.

The domain name server redirector also controls incoming data by establishing for each host it manages in the host database with a time-to-live (TTL) of, for example, one second so as to prevent other hosts anywhere on the Internet from having out-of-date host record information (i.e., working IP addresses). The domain name server redirector also controls outgoing data to meet predetermined output data performance requirements as per criteria held in the custom configuration database.

Using the domain name server redirector, the network load management apparatus may also move incoming traffic from one ISP to another. Each domain on the Internet is managed in terms of zones which are themselves defined in domain name servers. In one mode of operation, domain name server redirector operations are predicated to leverage the fact that when a zone is updated, addresses in that zone are also updated. Each zone that the network load management apparatus manages has a time-to-life (TTL) value assigned to it by the domain name server redirector. This TTL value is the maximum number of seconds that hosts on the Internet may cache the IP address associated with a zone before looking it up again. The network load management apparatus assigns this value to be, for example, equal to one second for all the zones it manages. This means, in this example, that at least every second, other hosts on the Internet must look up their own zone(s) again. The network load management apparatus dynamically changes its zones in real-time by changing the IP addresses assigned to its respective host devices so as to perform its primary functions (i.e., optimizing usage, rerouting when a connection fails, etc.).

The network load management apparatus is also capable of channel bonding. Channel bonding is the act of routing specific packets exclusively over a particular output port and a route. This may be achieved in order to satisfy specific delivery and/or quality of service objectives for traffic that may be viewed the high priority. Channel bonding may also be understood as pertaining to the case where two network load management apparatuses handshake and suspend randomization to allow for direct communication and passing encryption or other activities associated with quality of service. By suspending packet randomization, packets are thereby transmitted over a specific predetermined path between remote locations. Thus, the network load management apparatus of the present invention can provide up to 16 levels of virtual private networks. These modes of operation are selectable but are not programmable.

The network load management apparatus is also capable of transparent network management. Transparent network management is achieved by having distributed network load balancing devices communicating with one another to exchange quality of service statistics to a central site associated with the overall network. By sending packets from one site over multiple paths, various parameters associated with network alternatives may be gathered for future exploitation. By monitoring outside line-to-line availability, quality of service features, and, optionally, cost of the line, the network load management apparatus is able to reallocate packets amongst output ports to achieve optimum network performance. The network load management apparatus monitors whether an external line is up, is down, and/or is degraded. The network load management apparatus of the present invention does not require network management interaction after initialization. The software associated with the present invention is not reprogrammable, thereby ensuring much easier operations and training than other devices known to be available to the inventors. Using a typical large router configuration using BGP to load balance, an experienced engineer very familiar with BGP and the various ISP's involved must establish a custom configuration unique to each installation. In contrast, the network load management apparatus is menu driven thus simplifying equipment set up, operations, and maintenance. Prior art examples of network load balancers provide even distributions of load, without taking into account specific availability, quality of service, and line cost parameters feature.

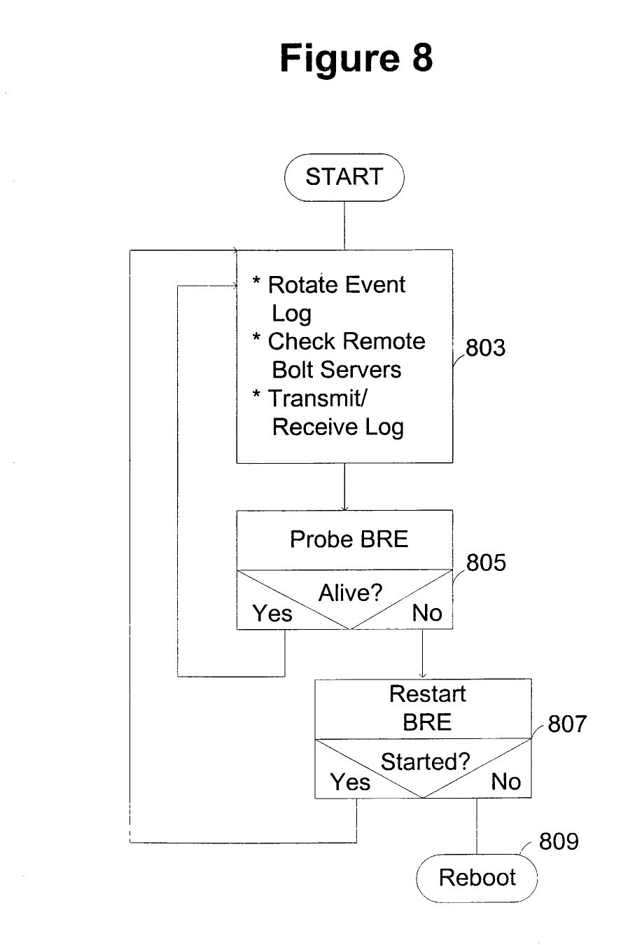

FIG. 8 is a flow diagram for the fail/safe guardian operation performed in module 603 of FIG. 8. The process starts by rotating the event log, checking various remote invention servers, and transmitting and/or receiving a log in step 803. Once this is done, the device probes the real-time executive 805 to determine whether the real-time executive is alive or not. If the real-time executive is alive, the method repeats the previous step of rotating event log, checking remote servers, and transmitting the log 803. If the real-time executive is not alive, the next step is to attempt to restart the real-time executive 807. If the real-time executive cannot restart, the device is rebooted 809. If the device can be restarted, the first step 801 is repeated.

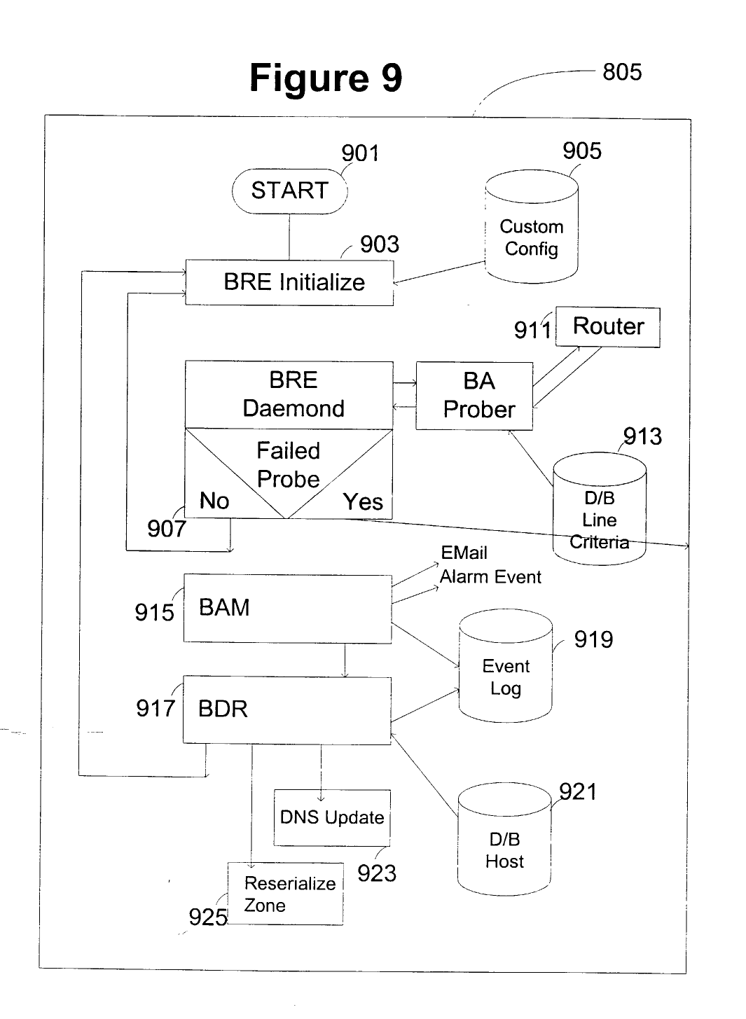

FIG. 9 is a flow diagram for the real-time executive 805. After starting 901, the real-time executive attempts to initialize 903. This includes retrieving initialization information from a custom configuration database 905. The custom configuration database contains site specific information unique to that site. Such information would be the various EP addresses of the various interfaces, location of router ports and basic configuration options. Once initialized, the real-time executive Daemon engages and attempts to determine whether the device is operating properly. A failed probe results in an attempt to reinitialize 903. A successful probe leads to initializing the alert manager 915. The alarm manager 915 may send an e-mail or another notification message upon successful alarm operations. In addition, if the alarm manager detects an alarm condition, an event is written into the event log 919. Next, the domain name server redirector 917 operates. If the domain name server detects a condition requiring a redirection of domain name servers, based upon information in the database host 921, an event is written in the event log 919, the domain name server table is updated 923, and the zone is re-serialized 925. Whether or not the domain name server detects a condition requiring a redirection of domain name servers 917, the domain name server redirector cannot update the domain name server information, the real-time executive is reinitialized. The basic asymmetric nature of TCP-IP permits various packets to be reassembled on each host or router in the local network. The IP address of local device sending the packet is used to search a table for a corresponding IP address of an ISP provider. The IP address of the EP next-hop is then set to the EP address of the ISP as determined by the table look-up. Finally, the packet is sent.

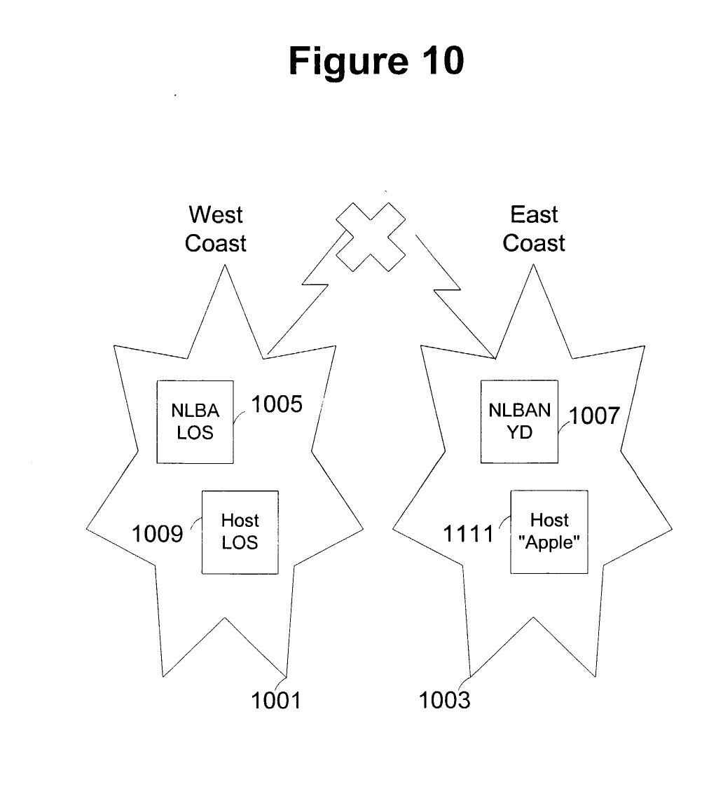

FIG. 10 is a block diagram showing an alternative embodiment of the present invention in which one network load management apparatus is configured to back up another remote network load management apparatus. In this example, West Coast Operations 1001 and East Coast Operations 1003 are configured to back each other up. In this situation, the West Coast network load management apparatus 1005 monitors the East Coast network load management apparatus 1007. If the West Coast network load management apparatus 1005 fails to reach the East Coast network load management apparatus 1007, the West Coast device 1005 immediately updates a mirror database with IP addresses that it can reach and then updates and re-serializes its update zone. In parallel, the East Coast network load management apparatus 1007 monitors the West Coast network load management apparatus 1005. If the East Coast network load management apparatus 1007 cannot reach the West Coast network load management apparatus 1005, the East Coast network load management apparatus 1007 immediately updates its mirror database with the IP addresses that it can reach and updates and re-serializes its local update zone. This monitoring operation is conducted independent from communications between the West Coast host 1009 and the East Coast host 1111.

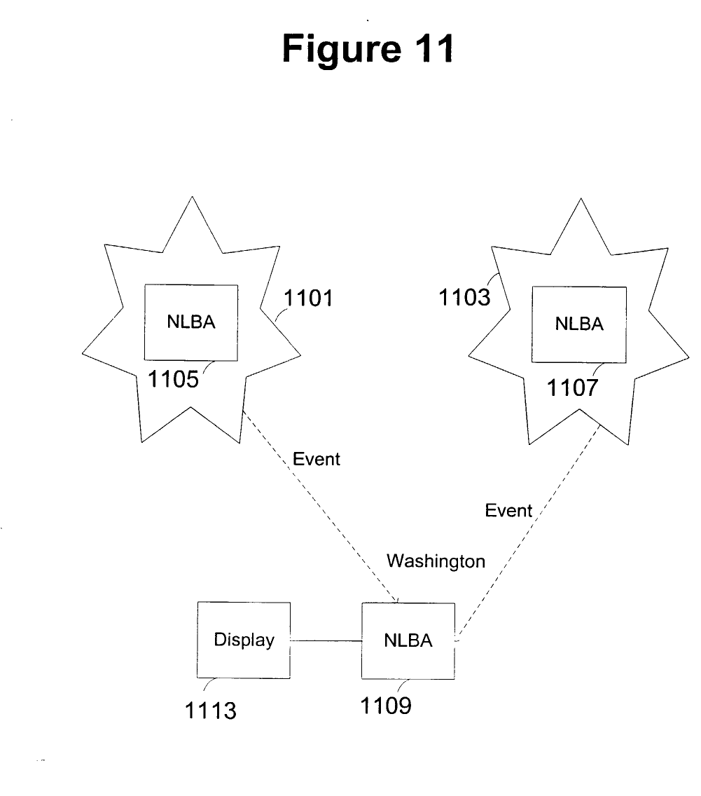

FIG. 11 is a block diagram showing how multiple network load management apparatuses may be managed from a central location. In this scenario, a first remote network load management apparatus 1105 located at a remote location 1101, and a second remote network load management apparatus 1107 at a second remote location 1103 each record events particular to its communications connectivity. These events are relayed to a third monitor network load management apparatus 1109 which records the information and provides other information back to its originating partners. The status of these remote devices may also be presented for display on a local display device 1113.

TABLE 1
ISP A-Address Assignment-192.1.1.0 and 192.1.1.255
ISP B-Address Assignment-193.1.1.0 and 193.1.1.255

| | | ISP A Detected | ISP B Detected |
|---|---|---|---|
| Device Address Assignments | | Condition | Condition |
| Device A | 192.1.1.1 or | UP | Up |
| | 193.1.1.1 | | |
| Device B | 192.1.1.2 or | | |
| | 193.1.1.2 | | |
| Device A | 192.1.1.1 or | Down | Up |
| | 193.1.1.1 | | |
| Device B | 192.1.1.2 or | | |
| | 193.1.1.2 | | |
| Device A | 192.1.1.1 or | Up | Down |
| | 193.1.1.1 | | |
| Device B | 192.1.1.2 or | | |
| | 193.1.1.2 | | |

Table 1 provides an example of this functionality. The system is configured so that Host A has ISP addresses 192.1.1.0 thru 192.1.1.255 assigned and Host B has addresses 193.1.1.0 thru 193.1.1.255 assigned. Under normal circumstances, both ISPs are up and Host A uses addresses 192.1.1.1 through 193.1.1.1 for external communications while Host B uses addresses 192.1.1.2 through 193.1.1.2 for external communications. If ISP A goes down, Host A will only use address 193.1.1.1 for external communications, and Host B will only use address 193.1.1.2 for external communications. If ISP B goes down, Host A will use 192.1.1.1 for external communications, and Host B will only use address 192.1.1.2 for external communications. If both go down, Host A and Host B will not be able to communicate externally. When a down ISP is detected as back up, then their addresses are restored.

In all configurations, the network load management apparatus of the present invention is capable of automatic reallocation of bandwidth based upon monitoring parameters associated with the independent ISP port connections. ISP ports are monitored for traffic levels, quality of service, and queue management parameters. When an output port is determined to provide a lower degree of service, the network load management apparatus automatically reallocates incoming datagrams to other, more preferable connections.

The network load management apparatus includes an analyzer module which probes ISP line condition “health” and compares these criteria to values stored in a customizable configuration database. If a line fails to meet a predetermined custom condition, the network load balancer real time executive launches a network load balancer application file to notify and log the event. Seventeen ISP line conditions that can be monitored include:

1. Ready terminal set;

2. Loop back state;

3. Input rate;

4. Output rate;

5. Input packets;

6. Output packets;

7. Input errors;

8. Buffer failures;

9. Cyclic redundancy check (CRC);

10. Frame errors (FE);

11. Overruns;

12. Abort;

13. Carrier transitions;

14. Data carrier detect (DCD);

15. Data set ready (DSR);

16. Data terminal ready (DTR); and

17. Clear to send (CTS).

It should be clear to one skilled in the art that other criteria may also be monitored and are within the scope of this invention.

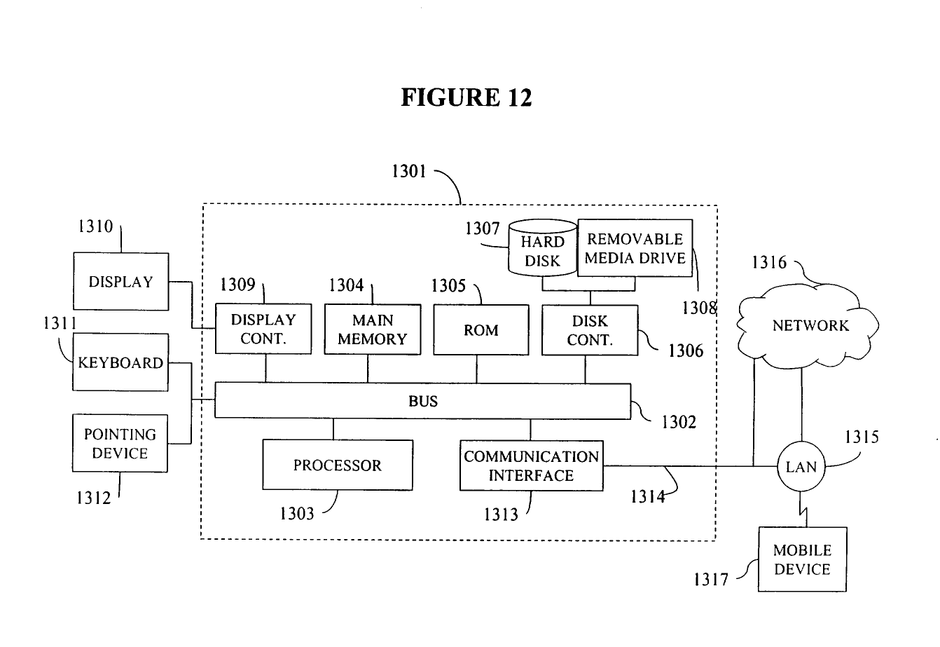

FIG. 12 illustrates a computer system 1301 upon which an embodiment of the present invention may be implemented. Many of the peripheral components are optionally included, as the network load balancing apparatus of the present invention may be implemented as a self-contained unit with an embedded process and associated software. Nevertheless, for illustrative purposes, the computer system 1301 includes a bus 1302 or other communication mechanism for communicating informnation, and a processor 1303 coupled with the bus 1302 for processing the information. The computer system 1301 also includes a main memory 1304, such as a random access memory (RAM) or other dynamic storage device (e.g., dynamic RAM (DRAM), static RAM (SRAM), and synchronous DRAM (SDRAM)), coupled to the bus 1302 for storing information and instructions to be executed by processor 1303. In addition, the main memory 1304 may be used for storing temporary variables or other intermediate information during the execution of instructions by the processor 1303. The computer system 1301 further includes a read only memory (ROM) 1305 or other static storage device (e.g., programmable ROM (PROM), erasable PROM (EPROM), and electrically erasable PROM (EEPROM)) coupled to the bus 1302 for storing static information and instructions for the processor 1303.

The computer system 1301 also includes a disk controller 1306 coupled to the bus 1302 to control one or more storage devices for storing information and instructions, such as a magnetic hard disk 1307, and a removable media drive 1308 (e.g., floppy disk drive, read-only compact disc drive, read/write compact disc drive, compact disc jukebox, tape drive, and removable magneto-optical drive). The storage devices may be added to the computer system 1301 using an appropriate device interface (e.g., small computer system interface (SCSI), integrated device electronics (IDE), enhanced-IDE (E-IDE), direct memory access (DMA), or ultra-DMA).

The computer system 1301 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1301 may also include a display controller 1309 coupled to the bus 1302 to control a display 1310, such as a cathode ray tube (CRT), for displaying information to a computer user. The computer system includes input devices, such as a keyboard 1311 and a pointing device 1312, for interacting with a computer user and providing information to the processor 1303. The pointing device 1312, for example, may be a mouse, a trackball, or a pointing stick for communicating direction information and command selections to the processor 1303 and for controlling cursor movement on the display 1310. In addition, a printer may provide printed listings of data stored and/or generated by the computer system 1301.

The computer system 1301 performs a portion or all of the processing steps of the network load management apparatus of the present invention in response to the processor 1303 executing one or more sequences of one or more instructions contained in a memory, such as the main memory 1304. Such instructions may be read into the main memory 1304 from another computer readable medium, such as a hard disk 1307 or a removable media drive 1308. One or more processors in a multi-processing arrangement may also be employed to execute the sequences of instructions contained in main memory 1304. In alternative embodiments, hard-wired circuitry may be used in place of or in combination with software instructions. Thus, embodiments are not limited to any specific combination of hardware circuitry and software.

As stated above, the computer system 1301 includes at least one computer readable medium or memory for holding instructions programmed according to the teachings of the network load management apparatus of the present invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1301, for driving a device or devices for implementing the network load management apparatus of the present invention, and for enabling the computer system 1301 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the network load management apparatus of the present invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1303 for execution. A computer readable medium may take many forms, including but not limited to, non-volatile media, volatile media, and transmission media. Non-volatile media includes, for example, optical, magnetic disks, and magneto-optical disks, such as the hard disk 1307 or the removable media drive 1308. Volatile media includes dynamic memory, such as the main memory 1304. Transmission media includes coaxial cables, copper wire and fiber optics, including the wires that make up the bus 1302. Transmission media also may also take the form of acoustic or light waves, such as those generated during radio wave and infrared data communications.

Various forms of computer readable media may be involved in carrying out one or more sequences of one or more instructions to processor 1303 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1301 may receive the data on the telephone line and use an infrared transmitter to convert the data to an infrared signal. An infrared detector coupled to the bus 1302 can receive the data carried in the infrared signal and place the data on the bus 1302. The bus 1302 carries the data to the main memory 1304, from which the processor 1303 retrieves and executes the instructions. The instructions received by the main memory 1304 may optionally be stored on storage device 1307 or 1308 either before or after execution by processor 1303.

The computer system 1301 also includes a communication interface 1313 coupled to the bus 1302. The communication interface 1313 provides a plurality (N) of two-way data communication coupling to a network link 1314 that is connected to, for example, a local area network (LAN) 1315, or to another communications network 1316 such as the Internet. For example, the communication interface 1313 may be a set of network interface cards attached to any packet switched LAN. Wireless links may also be implemented. In any such implementation, the communication interface 1313 sends and receives electrical, electromagnetic or optical signals that carry digital data streams representing various types of information.

The network link 1314 typically provides data communication through one or more networks to other data devices. For example, the network link 1314 may provide a connection to another computer through a local network 1315 (e.g., a LAN) or through equipment operated by a service provider, which provides communication services through a communications network 1316. The local network 1314 and the communications network 1316 use, for example, electrical, electromagnetic, or optical signals that carry digital data streams, and the associated physical layer (e.g., CAT 5 cable, coaxial cable, optical fiber, etc). The signals through the various networks and the signals on the network link 1314 and through the communication interface 1313, which carry the digital data to and from the computer system 1301 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1301 can transmit and receive data, including program code, through the network(s) 1315 and 1316, the network link 1314 and the communication interface 1313. Moreover, the network link 1314 may provide a connection through a LAN 1315 to a mobile device 1317 such as a personal digital assistant (PDA) laptop computer, or cellular telephone.

Obviously, numerous modifications and variations of the present invention are possible in light of the above teachings. It is therefore to be understood that within the scope of the appended claims, the invention may be practiced otherwise than as specifically described herein.

1. A network load management apparatus configured to balance a data load across a plurality of network connections, comprising:
a network condition monitoring module configured to monitor a network parameter from each of said plurality of network connections; and
an automatic data balancing module configured to balance said data load across said plurality of network connections in correspondence with said network parameter and a predetermined configuration parameter, wherein
said predetermined configuration parameter comprising at least one of
a predetermined output rate,
a predetermined output quality,
a cost,
a packet priority,
a security parameter, and
a queue size.

2. The apparatus of claim 1, wherein said network parameter comprises at least one of:
a ready terminal set parameter;
a loop back state parameter;
an input rate parameter;
an output rate parameter;
an input packet parameter;
an output packet parameter;
an input error parameter;
a buffer failure parameter;
a cyclic redundancy check (CRC) parameter;
a frame errors (FE) parameter;
an overruns parameter;
an abort parameter;
a carrier transition parameter;
a data carrier detect (DCD) parameter,
a data set ready (DSR) parameter;
a data terminal ready (DTR) parameter; and
a clear to send (CTS) parameter.

3. The apparatus of claim 1, further comprising:
a packet allocation module configured to allocate a plurality of non-randomized local packets corresponding to a local file to said plurality of network connections so as to create a first plurality of randomized transmission packets, and to re-aggregate a plurality of randomized received packets received from said plurality of network connections so as to create a replica of a plurality of non-randomized remote packets corresponding to a remote file.

4. The apparatus of claim 3, wherein
said packet allocation module is further configured to pad at least one of said plurality of non-randomized local packets.

5. The apparatus of claim 3, further comprising
a channel bonding module configured to allocate data packets from another local file to a subset of said plurality of network connections.

6. The apparatus of claim 5, wherein
said channel bonding module is further configured to allocate said plurality of non-randomized local packets corresponding to said local file to a subset of said plurality of network connections.

7. The apparatus of claim 3, wherein
said packet allocation module is further configured to add a dynamic encryption local file identifier to said plurality of non-randomized local packets corresponding to said local file.

8. The apparatus of claim 1, further comprising:
a dynamic domain name server redirector module configured to redirect a network address in correspondence with said network parameter and said predetermined configuration parameter.

9. The apparatus of claim 8, wherein
said dynamic domain name server redirector module is further configured to establish a predetermined time-to-live constraint for a predetermined host.

10. The apparatus of claim 1, further comprising:
a remote network load management apparatus monitor and backup module configured to monitor and backup a second network load management apparatus;
a network load management apparatus remote status reporting module configured to provide local status information to one of said second remote network load management apparatus and a third remote network load management apparatus; and
network load management apparatus remote control module configured to receive remote control information from one of said second remote network load management apparatus and said third remote network load management apparatus.

11. The apparatus of claim 1, further comprising:
an event log writer; and
an alarm manager, wherein
said alarm manager is configured to write an event in said event log and to send at least one of a notification email message, a notification facsimile message, and a notification page message when a predetermined alarm condition is detected.

12. The apparatus of claim 11, wherein
said alarm manager is further configured to perform at least one of turn on a backup power source, execute a remote configuration change operation in a router, and execute a remote configuration change operation in a host device in response to said predetermined alarm condition.

13. The apparatus of claim 1, further comprising:
a command input module; and
a status display module.

14. A network load management apparatus configured to balance a data load across a plurality of network connections, comprising:
means for monitoring a network parameter from each of said plurality of network connections; and
means for automatic balancing said data load across said plurality of network connections in correspondence with said network parameter and a predetermined configuration parameter, wherein
said predetermined configuration parameter comprising at least one of
a predetermined output rate,
a predetermined output quality,
a cost,
a packet priority,
a security parameter, and
a queue size.

15. A system configured to balance data packet loads across a plurality of network connections, comprising:
a first network load management apparatus connecting a first host device to at least one network via a first plurality of network connections; and
a second network load management apparatus connecting a second host device to said at least one network via a second plurality of network connections, wherein
said first host device and said second host device are configured to exchange data packets with each other, and
said first network load management apparatus and said second network load management apparatus each includes
a network condition monitoring module configured to monitor a network parameter from each of a respective plurality of network connections, and
an automatic data balancing module configured to balance said data load across said respective plurality of network connections in correspondence with said network parameter and a predetermined configuration parameter, said predetermined configuration parameter comprising at least one of
a predetermined output rate,
a predetermined output quality,
a cost,
a packet priority,
a security parameter, and
a queue size.

16. The system of claim 15, wherein
said first network load management apparatus is connected to said at least one network via a third network load management apparatus.

17. The system of claim 15, wherein
said second network load management apparatus is connected to said at least one network via a fourth network load management apparatus.

18. The system of claim 15, wherein
said first network load management apparatus is connected to said first host device via a router.

19. The system of claim 15, wherein
said first network load management apparatus connects to said first host device via a firewall.

20. The system of claim 15, further comprising:
a fifth network load management apparatus configured to monitor and control at least one of said first network load management apparatus and said second network load management apparatus.

21. The system of claim 15, further comprising:
an encryption device configured to encrypt an output of said first network load management apparatus; and
a decryption device configured to decrypt an input to said second network load management apparatus.

22. A method for managing network data loads between a plurality of host devices and a plurality of network connections, comprising steps of:
monitoring a network parameter from each of said plurality of network connections; and
automatically balancing said data load across said plurality of network connections in correspondence with said network parameter and a predetermined configuration parameter, wherein
said predetermined configuration parameter is at least one of
a predetermined output rate,
a predetermined output quality,
a cost,
a packet priority,
a security parameter, and
a queue size.

23. The method of claim 22, wherein said network parameter comprises at least one of:
a ready terminal set parameter;
a loop back state parameter;
an input rate parameter;
an output rate parameter;
an input packet parameter;
an output packet parameter;
an input error parameter;
a buffer failure parameter;
a cyclic redundancy check (CRC) parameter;
a frame errors (FE) parameter;
an overruns parameter;
an abort parameter;
a carrier transition parameter;
a data carrier detect (DCD) parameter;
a data set ready (DSR) parameter;
a data terminal ready (DTR) parameter; and
a clear to send (CTS) parameter.

24. The method of claim 22, further comprising one of a step of:
allocating a plurality of non-randomized local packets corresponding to a local file to said plurality of network connections so as to create a first plurality of randomized transmission packets; and
re-aggregating a plurality of randomized received packets received from said plurality of network connections so as to create a replica of a plurality of non-randomized remote packets corresponding to a remote file.

25. The method of claim 24, further comprising a step of:
padding at least one of said plurality of non-randomized local packets.

26. The method of claim 24, further comprising a step of:
adding a dynamic encryption local file identifier to said plurality of non-randomized local packets corresponding to said local file.

27. The method of claim 24, further comprising a step of:
allocating data packets from another local file to a subset of said plurality of network connections.

28. The method of claim 27, further comprising a step of:
allocating said plurality of non-randomized local packets corresponding to a local file to a subset of said plurality of network connections.

29. The method of claim 22, further comprising a step of:
redirecting a network address in correspondence with said network parameter and said predetermined configuration parameter.

30. The method of claim 29, further comprising a step of:
establishing a time-to-live constraint for a predetermined host.

31. The method of claim 22, further comprising a step of:
remotely monitoring and backing up a second network load management apparatus.

32. The method of claim 31, further comprising a step of:
controlling at least one of said first network load management apparatus and said second network load management apparatus by a third network load management apparatus.

33. The method of claim 22, further comprising steps of:
writing an event in an event log when a predetermined alarm condition is detected; and
sending at least one of a notification email message, a notification facsimile message, and a notification page message.

34. The method of claim 33, further comprising at least one of a step of:
turning on a backup power source;
executing a remote configuration change operation in a router; and
executing a remote configuration change operation in a host device.

35. The method of claim 22, further comprising steps of:
inputting commands and configuration information via a command input module; and
displaying a status in a status display module.

36. A computer program product comprising a plurality of instructions for managing network data loads between a plurality of host devices and a plurality of network connections, comprising:
instructions for monitoring a network parameter from each of said plurality of network connections; and
instructions for automatically balancing said data load across said plurality of network connections in correspondence with said network parameter and a predetermined configuration parameter, wherein
said predetermined configuration parameter is at least one of
a predetermined output rate,
a predetermined output quality,
a cost,
a packet priority,
a security parameter, and
a queue size.

37. The computer program product of claim 36, wherein said network parameter comprises at least one of:
a ready terminal set parameter;
a loop back state parameter;
an input rate parameter;
an output rate parameter;
an input packet parameter;
an output packet parameter;
an input error parameter;
a buffer failure parameter;
a cyclic redundancy check (CRC) parameter;
a frame errors (FE) parameter;
an overruns parameter;
an abort parameter;
a carrier transition parameter;
a data carrier detect (DCD) parameter;
a data set ready (DSR) parameter;
a data terminal ready (DTR) parameter; and
a clear to send (CTS) parameter.
